(19) United States
(12) Patent Application Publication
(10) Pub. No.: US 2025/0146392 A1
(43) Pub. Date: May 8, 2025

(54) REAL-TIME MONITORING SYSTEM FOR INTERNAL ENVIRONMENT OF OIL WELL PLATFORM

(71) Applicant: Ludong University, Yantai City (CN)

(72) Inventors: Chao ZHAN, Yantai City (CN); Qing WANG, Yantai City (CN); Hongyuan SHI, Yantai City (CN); Jun ZHU, Yantai City (CN); Teng SU, Yantai City (CN); Yan LI, Yantai City (CN); Jun YUE, Yantai City (CN)

(21) Appl. No.: 18/420,918

(22) Filed: Jan. 24, 2024

(30) Foreign Application Priority Data
Nov. 7, 2023 (CN) 2023114777170

(51) Int. Cl. E21B 43/16

(52) U.S. Cl. CPC E21B 43/16

(57) ABSTRACT

The disclosure relates to a technical field of oil monitoring, and in particular to real-time monitoring system for an internal environment of an oil well platform. The system includes: a group of Internet of Things sensors used for collecting data of the internal environment of the oil well platform in real time; a satellite transmission unit communicated with a plurality of Internet of Things sensors and used for receiving data collected by the Internet of Things sensors; the satellite receiving terminal used for receiving data from the satellite transmission unit and transmitting data to a central server; the central server with a data processing function used for receiving data from the satellite receiving terminal and carrying out data integration and analysis; and a control center used for displaying monitoring results and data trends from the central server, and issuing early warning or alarm based on a preset environmental parameter standard.

### TECHNICAL FIELD

The disclosure relates to a technical field of oil monitoring, and in particular to a real-time monitoring system for an internal environment of an oil well platform.

### BACKGROUND

With the rapid growth of global energy demand, oil exploitation has become an important part of industrial production. However, oil drilling operations are often faced with extreme geographical environment and complex technical challenges, such as extreme temperature, high pressure environment and toxic gas leakage, which pose a great threat to the safety of equipment, environment and personnel. Conventional monitoring methods rely on regular inspections and manual data recording by field staff, which is not only inefficient, but also may miss potential safety risks due to human negligence or the limitation of testing equipment.

In addition, a large number of environmental parameters and equipment performance data need to be monitored and analyzed in real time, and the conventional methods have high delay in data collection, transmission and processing, which cannot realize real-time and accurate decision-making. In addition, scattered data sources and inconsistent data formats have greatly increased the difficulty of data integration and affected the accuracy and relevance of data analysis.

In order to solve these problems, a highly integrated solution is urgently needed. The solution is capable of automatically collecting and transmitting data, ensuring real-time monitoring, and is also capable of conducting advanced data analysis and intelligent early warning. Internet of Things (IoT) technology has attracted attention because of its ability of automatic data collection and remote monitoring, but how to effectively integrate data from different sources, process a large amount of data in real time, and how to apply advanced data analysis algorithms to anomaly detection and prediction are still technical challenges to be overcome in this field.

### SUMMARY

Based on the above purpose, the present disclosure provides a real-time monitoring system for an internal environment of an oil well platform.

A real-time monitoring system for the internal environment of the oil well platform includes:
a group of Internet of Things sensors, used for collecting data of the internal environment of the oil well platform in real time, where the data includes temperature, humidity, dust condition, water quality, toxic gas and pressure;
a satellite transmission unit, communicated with a plurality of Internet of Things sensors and used for receiving data collected by the Internet of Things sensors and sending the data to a satellite receiving terminal through satellite transmission;
the satellite receiving terminal, used for receiving data from the satellite transmission unit and transmitting the data to a central server;
the central server, with a data processing function, used for receiving the data from the satellite receiving terminal and carrying out data integration and analysis; and
a control center, with a user interface, used for displaying monitoring results and data trends from the central server, and issuing an early warning or alarm based on a preset environmental parameter standard.

Further, the Internet of Things sensors collect the data in real time at predetermined time intervals and transmit the data for subsequent processing.

Further, the Internet of Things sensors specifically include:
temperature sensors, humidity sensors, dust and particle sensors, water quality sensors, toxic gas sensors and pressure sensors.

Further, the satellite transmission unit stores, analyzes and transmits the data to the satellite receiving terminal of a base through edge computing equipment, specifically including:
data acquisition and preliminary processing:
the data collected by the Internet of Things sensors in real time are preprocessed by the edge computing equipment, where preprocessing includes data cleaning and data compression;
edge computing and data analysis:
the edge computing equipment runs an internal data analysis algorithm to identify anomalies from the data of the Internet of Things sensors; and
data storage and warehousing:
on the edge computing equipment, the data meeting the standard or being considered important is stored in an internal memory to form a local database; and the edge computing equipment archives or deletes non-critical data regularly according to a configuration strategy to optimize storage resources.

The satellite receiving terminal receives data.

Further, after completing data preprocessing and analysis, the edge computing equipment transmits analyzed data and analysis results to the satellite transmission unit, and the satellite transmission unit converts the data into a signal format transmitted in the air through high-frequency antennas and modulators, and transmits the data to a target satellite;
when a data signal reaches a satellite in a geosynchronous orbit, a receiver of the satellite captures and demodulates the data signal, and restores the data signal to an original data format. A transponder of the satellite modulates data again and transmits the data back to the earth through different frequencies and beams, a target is the satellite receiving terminal on the ground.

The satellite receiving terminal includes an antenna, a low-noise amplifier and a receiver, and captures a signal transmitted from the satellite; the receiver demodulates the signal, restores the original data format, and checks and corrects the data through an internal processing system to ensure an integrity and an accuracy of the data; and
after receiving and processing, the satellite receiving terminal transmits the data to the central server through wired or wireless networks.

Further, the central server specifically includes:
data receiving and preliminary processing:
receiving multi-source data from the satellite receiving terminal, where the multi-source data reflects environmental conditions in the oil well platform, including temperature, humidity, dust condition, water quality, toxic gas and pressure data; and preprocessing the received data, including verifying data integrity, correcting errors and removing redundant or inconsistent information;
data integration:
through principal component analysis, data from different sensors and devices are integrated to ensure a compatibility and a consistency of various data, and cleaned data are stored in a structured database by using a database management system to realize functions of data organization, query and retrieval; and
data analysis:
using a data analysis technology and a machine learning algorithm deeply analyzing the integrated data in the database, including pattern recognition, anomaly detection and trend prediction; and
using an artificial intelligence technology, explaining analysis results, identifying environmental risk factors, predicting future conditions, and generating corresponding reports.

Further, the principal component analysis specifically includes following steps:
standardizing the data to obtain a standardized data matrix Z;
calculating a covariance matrix to find principal component of the data; for the standardized data matrix Z, defining the covariance matrix C as:

$$C = \frac{1}{n - 1} {Z}^{T} Z ,$$

where Z^{T} represents an transposition of Z, and n represents a number of samples;
calculating an eigenvalue λ and an eigenvector v: Cv=λv;
selecting the principal component:
after finding eigenvalues and eigenvectors, sorting eigenvalues from large to small, where a eigenvector corresponding to first k largest eigenvalues is first k principal components, and transforming original data into a new space through the eigenvector;
data transformation:
transforming the original data matrix X into a new low-dimensional data matrix Y through selected principal components: Y=Zvₖ,
where vₖ represents a matrix composed of the first k principal components.

Further, the data analysis technology of a central processing unit is based on an autoregressive moving average model, and the model formula is:

$$Xt = c + {φ}_{1} {Xt}_{- 1} + … + φ pXt - t - {θ}_{1} ε {t}_{- 1} - … - θ q εt\_q + ε t ,$$

where
Xt represents time series data, c represents a constant term; φ₁ to φp represent parameters of an autoregressive term, and describes a dependence of past p periods; θ₁ to θq represent parameters of a moving average term, and describes a dependence of a model error term; εt represents an error term, assuming white noise; p, q represent respectively orders of the autoregressive term and the moving average term. The model predicts a future value of time series by combining past observation values and past errors.

Further, the machine learning algorithm of the central processing unit is based on Random Forest, and a formula is:

$$Y = ( 1 / N ) \times \sum ( {T}_{i} ( X ) ) ,$$

where
Y represents a predicted output, N represents a number of decision trees, Tᵢ(X) represents a prediction of an i-th tree, and X represents an input variable.

Further, the control center specifically includes:
definition of safety parameters: according to historical data and industry safety standards, defining a safety range and a warning line of each monitoring factor;
real-time data monitoring: monitoring well site environment in real time by using the sensor data collected by the edge computing equipment, and synchronizing the data to the central database after preprocessing and analysis;
anomaly detection algorithm: constantly comparing real-time data with a normal operating range, and triggering an anomaly detection protocol immediately in case of any deviation from preset security parameters, where the anomaly detection algorithm is anomaly detection based on clustering, normal data is considered to constitute “clusters” in a data set, and outliers are points far away from the nearest cluster; the algorithm first clusters the data, and then identifies data points not belong to the clusters; and
early warning signal triggering: once the parameters are detected to be beyond the safe range or reach the warning line, the early warning system automatically triggers, and immediately sends out visual and audible alarms in the control center through the built-in communication module.

The disclosure has following beneficial effects.

In the disclosure, the advanced monitoring system implemented by the Internet of Things (IoT) technology plays a key role. Firstly, various sensors are installed to monitor key indicators such as temperature, humidity, dust, water quality, toxic gas and pressure, and these data are collected in real time and sent through the satellite transmission system. The edge computing equipment plays a key role in the data transmission process, not only storing data, but also performing preliminary analysis before transmitting the data to the satellite receiving terminal, the satellite receiving terminal sends the data to the central server to prepare for the next data integration and in-depth analysis.

According to the disclosure, the advanced data processing algorithm is adopted in the central server to integrate data from different sensors, so as to ensure the compatibility and consistency between the data; through time series analysis, clustering, density evaluation, isolated forest and other algorithms, the system is capable of carrying out deep learning, and realizing pattern recognition, anomaly detection and trend prediction; in particular, the anomaly detection algorithm allows the system to identify possible abnormal patterns without preset specific thresholds, thereby enhancing the response ability to unknown threats.

According to the disclosure, the real-time monitoring of various conditions of the drilling platform is realized, and the safety and efficiency are improved; based on the result of data processing, the early warning system is capable of responding in time; once any parameter is detected to be out of the normal range or reach a dangerous level, the early warning system immediately triggers an alarm and transmits the alarm information to relevant departments and personnel, which not only reduces the potential work interruption and production loss, but also greatly reduces the risk of major accidents, and protects the safety of equipment, environment and field workers.

### BRIEF DESCRIPTION OF THE DRAWINGS

In order to explain the technical scheme of the present disclosure or the prior art more clearly, the drawings needed to be used in the description of the embodiment or the prior art are briefly introduced below. Obviously, the drawings in the following description are only the present disclosure, and other drawings may be obtained according to these drawings without creative work for ordinary people in the field.

FIG. 1 is a schematic diagram of modules and units of the system according to an embodiment of the present disclosure.

FIG. 2 is a schematic diagram of data transmission of the system according to an embodiment of the present disclosure.

FIG. 3 is a schematic diagram of Internet of Things monitoring according to an embodiment of the present disclosure.

### DETAILED DESCRIPTION OF THE EMBODIMENTS

In order to make the purpose, technical scheme and advantages of the present disclosure more clear, the present disclosure is further described in detail with specific embodiments.

It should be noted that, unless otherwise defined, technical terms or scientific terms used in the present disclosure should have their ordinary meanings as understood by people with ordinary skills in the field to which the present disclosure belongs. The terms “first”, “second” and the like used in the present disclosure do not indicate any order, quantity or importance, but are only used to distinguish different components. Similar words such as “including” or “comprising” mean that the elements or objects appearing before the word cover the elements or objects listed after the word and their equivalents, without excluding other elements or objects. Similar words such as “connected” or “linked” are not limited to physical or mechanical connection, but are capable of including electrical connection, whether direct or indirect. “Up”, “down”, “left” and “right” are only used to indicate the relative positional relationship. When the absolute position of the described object changes, the relative positional relationship may also change accordingly.

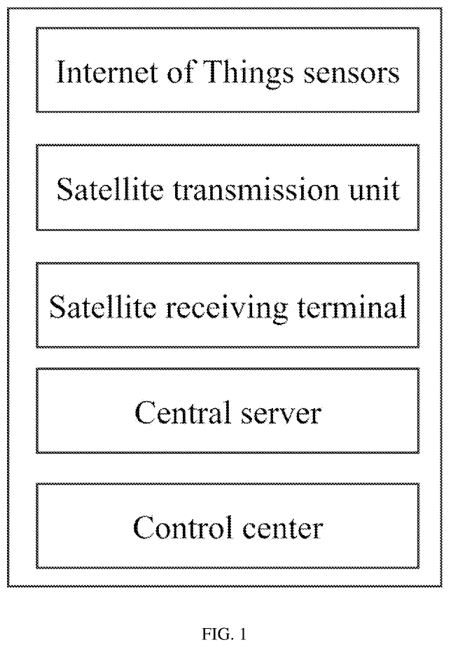

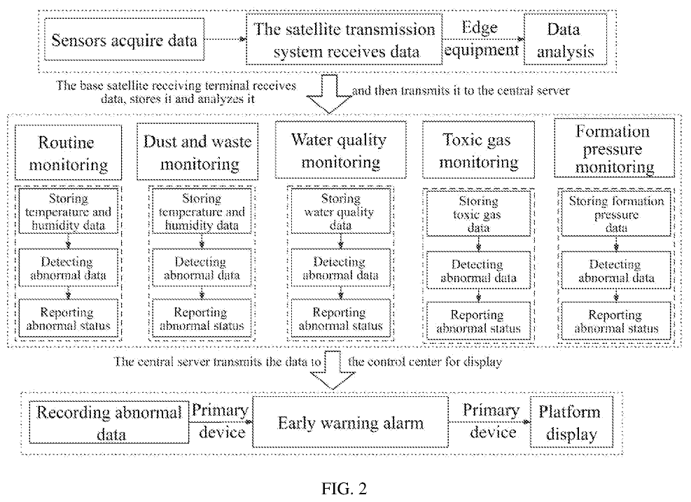

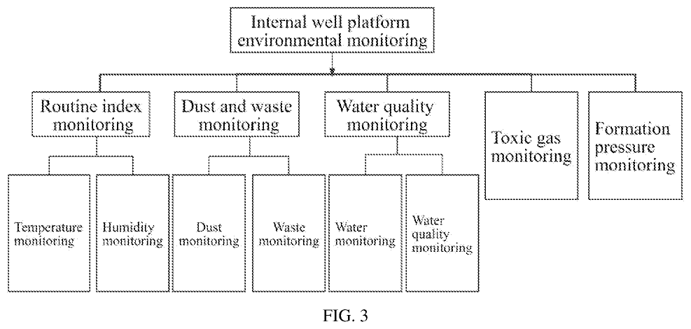

As shown in FIG. 1, FIG. 2 and FIG. 3, a real-time monitoring system for internal environment of an oil well platform includes:
a group of Internet of Things sensors, used for collecting data of the internal environment of the oil well platform in real time, where the data includes temperature, humidity, dust condition, water quality, toxic gas and pressure;
a satellite transmission unit, communicated with a plurality of Internet of Things sensors and used for receiving data collected by the Internet of Things sensors and sending the data to a satellite receiving terminal through satellite transmission;
the satellite receiving terminal, used for receiving data from the satellite transmission unit and transmitting the data to a central server; and
the central server, with a data processing function, used for receiving the data from the satellite receiving terminal and carrying out data integration and analysis; and
a control center, with a user interface, used for displaying monitoring results and data trends from the central server, and issuing an early warning or alarm based on a preset environmental parameter standard.

The Internet of Things sensors collect the data in real time at predetermined time intervals and transmit the data for subsequent processing.

The Internet of Things sensors specifically include:
temperature sensors:
the temperature sensors use thermistors or thermocouples to detect a change of environmental temperature, and have a following working principle: when the temperature of a substance changes, its electrical characteristics (resistance or voltage) changes accordingly; and
in the oil well platform, the temperature sensors are placed in key positions to continuously monitor the temperature, because abnormal temperature rise may indicate overheating of equipment or potential fire risk;
humidity sensors:
The humidity sensors detect the moisture content in the air. Based on a principle of capacitance or resistance, the change of humidity leads to the change of dielectric capacitance or resistance value in the sensors; and
on the well platform, humidity control is very important to prevent corrosion or other equipment problems caused by excessive humidity;
dust and particle sensors:
the dust and particle sensors use a principle of laser scattering to detect suspended particles in the air; when the laser shines on the particles, it scatters and forms a scattered light pattern on the photodiode; and
for the oil well platform, monitoring dust and other suspended particles helps to ensure air quality and prevent potential respiratory-related health problems;
water quality sensors:
the water quality sensors measure pH value, dissolved oxygen, conductivity and other variables related to water quality, and detect the concentration of specific chemicals by electrochemical methods, such as using ion-sensitive electrodes; and
in the process of oil exploitation, monitoring water quality is very important for environmental protection and compliance with safety standards;
toxic gas sensors:
the toxic gas sensors detect toxic or combustible gases such as methane, carbon dioxide, hydrogen sulfide, etc., generally based on electrochemical or infrared sensing technology, the toxic gas sensors is capable of detecting the chemical or optical reaction between specific gas molecules and the sensor surface; and
the safety of the well platform is extremely dependent on these sensors, because they are capable of detecting leakage in time and preventing potential explosion or poisoning events; and
pressure sensors:
the pressure sensors detect the pressure of liquid or gas and convert the pressure of liquid or gas into electrical signal based on principles of piezoresistance, capacitance and piezoelectricity; and
in the oil well platform, pressure monitoring is very important to avoid equipment overload and ensure the structural integrity of pipelines and storage tanks.

The satellite transmission unit stores, analyzes and transmits the data to the satellite receiving terminal of a base through edge computing equipment, specifically including:
data acquisition and preliminary processing:
the data collected by the Internet of Things sensors in real time are preprocessed by the edge computing equipment, where preprocessing includes data cleaning (filtering abnormal or incomplete data) and data compression;
edge computing and data analysis:
the edge computing equipment runs an internal data analysis algorithm to identify anomalies from the data of the Internet of Things sensors; for example, abnormal data analysis is capable of quickly identifying potential safety or environmental risks, such as gas leakage, equipment failure or other key conditions;
data storage and warehousing:
on the edge computing equipment, the data meeting the standard or being considered important is stored in an internal memory to form a local database, which not only provides data backup, but also allows quick access to historical data for trend analysis and predictive maintenance; and the edge computing equipment archives or deletes non-critical data regularly according to a configuration strategy to optimize storage resources; and
based on the priority and real-time requirements, key data and analysis results are transmitted to the main control center in real time, and the edge equipment sends these data through the satellite transmission system installed on the well platform.

Satellite communication provides a reliable way to successfully transmit data to global operation centers or other satellite receiving terminals even in remote or geographically challenging areas.

The satellite receiving terminal receives data.

After completing data preprocessing and analysis, the edge computing equipment transmits analyzed data and analysis results to the satellite transmission unit, and the satellite transmission unit converts the data into a signal format transmitted in the air through high-frequency antennas and modulators, and transmits the data to a target satellite;
when a data signal reaches a satellite in a geosynchronous orbit, a receiver of the satellite captures and demodulates the data signal, and restores the data signal to an original data format. A transponder of the satellite modulates data again and transmits the data back to the earth through different frequencies and beams, a target is the satellite receiving terminal on the ground.

The satellite receiving terminal includes an antenna, a low-noise amplifier and a receiver, and captures a signal transmitted from the satellite; the receiver demodulates the signal, restores the original data format, and checks and corrects the data through an internal processing system to ensure an integrity and an accuracy of the data; and
after receiving and processing, the satellite receiving terminal transmits the data to the central server through wired or wireless networks.

The central server specifically includes:
data receiving and preliminary processing:
receiving multi-source data from the satellite receiving terminal, where the multi-source data reflects environmental conditions in the oil well platform, including temperature, humidity, dust condition, water quality, toxic gas and pressure data; and preprocessing the received data, including verifying data integrity, correcting errors and removing redundant or inconsistent information;
data integration:
through principal component analysis, data from different sensors and devices are integrated to ensure a compatibility and a consistency of various data, and cleaned data are stored in a structured database by using a database management system to realize functions of data organization, query and retrieval; and
data analysis:
using a data analysis technology and a machine learning algorithm deeply analyzing the integrated data in the database, including pattern recognition, anomaly detection and trend prediction; and
using an artificial intelligence technology, explaining analysis results, identifying environmental risk factors, predicting future conditions, and generating corresponding reports.

The principal component analysis method specifically includes:
standardizing the data to obtain a standardized data matrix Z;
calculating a covariance matrix to find principal component of the data; for the standardized data matrix Z, defining the covariance matrix C as:

$$C = \frac{1}{n - 1} {Z}^{T} Z ,$$

where Z^{T} represents an transposition of Z, and n represents a number of samples;
calculating an eigenvalue λ and an eigenvector v: Cv=λv;
selecting the principal component:
after finding eigenvalues and eigenvectors, sorting eigenvalues from large to small,
where a eigenvector corresponding to first k largest eigenvalues is first k principal components, and transforming original data into a new space through the eigenvector;
data transformation:
transforming the original data matrix X into a new low-dimensional data matrix Y through selected principal components (feature vectors): Y=Zvₖ,
where vₖ represents a matrix composed of the first k principal components.

The data collected by various sensors (such as temperature, humidity, pressure, etc.) may be regarded as different characteristics of data matrix X. Because the data may be different in order of magnitude and nature, direct analysis may lead to wrong interpretation. At this time, PCA algorithm becomes very useful.

Data aggregation: multi-dimensional data from different sensors are first standardized to ensure that each dimension has the same impact on the final result.

Dimension reduction and feature extraction: principal component analysis (PCA) helps identify which principal components capture the most information and variability, which is very important for understanding the main influencing factors of sensor readings, not only reducing the amount of data to be analyzed, but also eliminating noise and unnecessary information, thus simplifying the subsequent data processing and analysis.

Prediction model construction: with the data converted by PCA, a prediction model may be established with less main components, thus improving the calculation efficiency and possibly improving the prediction accuracy of the model.

The data analysis technology of a central processing unit is based on an autoregressive moving average model, and the model formula is:

$$Xt = c + {φ}_{1} {Xt}_{- 1} + … + φ pXt - t - {θ}_{1} ε {t}_{- 1} - … - θ q εt\_q + ε t ;$$

where
Xt represents time series data, c represents a constant term; φ₁ to φp represent parameters of an autoregressive term, and describes a dependence of past p periods; θ₁ to θq represent parameters of a moving average term, and describes a dependence of a model error term; εt represents an error term, assuming white noise; p, q represent respectively orders of the autoregressive term and the moving average term. The model predicts a future value of time series by combining past observation values and past errors.

The machine learning algorithm of the central processing unit is based on Random Forest, and a formula is:

$$Y = ( 1 / N ) \times \sum ( {T}_{i} ( X ) )$$

where
Y represents a predicted output, N represents a number of decision trees, Tᵢ(X) represents a prediction of an i-th tree, and X represents an input variable.

The control center specifically includes:
definition of safety parameters: according to historical data and industry safety standards, defining a safety range and a warning line of each monitoring factor (such as temperature, pressure, toxic gas concentration, etc.);
real-time data monitoring: monitoring well site environment in real time by using the sensor data collected by the edge computing equipment, and synchronizing the data to the central database after preprocessing and analysis;
anomaly detection algorithm: constantly comparing real-time data with a normal operating range, and triggering an anomaly detection protocol immediately in case of any deviation from preset security parameters, where the anomaly detection algorithm is anomaly detection based on clustering, normal data is considered to constitute “clusters” in a data set, and outliers are points far away from the nearest cluster; the algorithm first clusters the data, and then identifies data points not belong to the clusters;
using clustering algorithms such as K-means or DBSCAN to group data points, normal data should be clustered together, while abnormal data points do not belong to any cluster or are significantly distant from the nearest cluster.

Early warning signal triggering: once the parameters are detected to be beyond the safe range or reach the warning line, the early warning system automatically triggers, and immediately sends out visual and audible alarms in the control center through the built-in communication module;
through wireless communication means, the alarm information is sent to relevant end users (such as field staff and emergency response team) in real time to ensure that they responds quickly. The early warning system is also integrated with emergency response protocol to automatically guide field personnel to take appropriate safety measures, such as evacuating, shutting down the system or adopting other necessary coping strategies.

It should be understood by those skilled in the art that the discussion of any of the above embodiments is only exemplary, and it is not intended to imply that the scope of the present disclosure is limited to these examples; under the idea of the present disclosure, the technical features in the above embodiments or different embodiments may also be combined, and the steps may be realized in any order, and there are many other variations in different aspects of the present disclosure as described above, which are not provided in the details for brevity.

The present disclosure is intended to cover all such alternatives, modifications and variations that fall within the broad scope of the claims. Therefore, any omission, modification, equivalent substitution, improvement, etc. within the spirit and principle of the disclosure should be included in the protection scope of the disclosure.

What is claimed is:

1. A real-time monitoring system for internal environment of an oil well platform, comprising:
a group of Internet of Things sensors, used for collecting data of the internal environment of the oil well platform in real time, wherein the data comprises temperature, humidity, dust condition, water quality, toxic gas and pressure;
a satellite transmission unit, communicated with a plurality of Internet of Things sensors and used for receiving data collected by the Internet of Things sensors and sending the data to a satellite receiving terminal through satellite transmission;
the satellite receiving terminal, used for receiving data from the satellite transmission unit and transmitting the data to a central server; and
the central server, with a data processing function, used for receiving the data from the satellite receiving terminal and carrying out data integration and analysis; and
a control center, with a user interface, used for displaying monitoring results and data trends from the central server, and issuing an early warning or alarm based on a preset environmental parameter standard.

2. The real-time monitoring system for the internal environment of the oil well platform according to claim 1, wherein the Internet of Things sensors collect the data in real time at predetermined time intervals and transmit the data for subsequent processing.

3. The real-time monitoring system for the internal environment of the oil well platform according to claim 2, wherein the Internet of Things sensors specifically comprise:
temperature sensors, humidity sensors, dust and particle sensors, water quality sensors, toxic gas sensors and pressure sensors.

4. The real-time monitoring system for the internal environment of the oil well platform according to claim 3, wherein the satellite transmission unit stores, analyzes and transmits the data to the satellite receiving terminal of a base through edge computing equipment, specifically comprising:
data acquisition and preliminary processing:
the data collected by the Internet of Things sensors in real time are preprocessed by the edge computing equipment, wherein preprocessing comprises data cleaning and data compression;
edge computing and data analysis:
the edge computing equipment runs an internal data analysis algorithm to identify anomalies from the data of the Internet of Things sensors; and
data storage and warehousing:
on the edge computing equipment, the data meeting the standard or being considered important is stored in an internal memory to form a local database; and the edge computing equipment archives or deletes non-critical data regularly according to a configuration strategy to optimize storage resources; and
the satellite receiving terminal receives data.

5. The real-time monitoring system for the internal environment of the oil well platform according to claim 4, wherein after completing data preprocessing and analysis, the edge computing equipment transmits analyzed data and analysis results to the satellite transmission unit, and the satellite transmission unit converts the data into a signal format transmitted in the air through high-frequency antennas and modulators, and transmits the data to a target satellite;
when a data signal reaches a satellite in a geosynchronous orbit, a receiver of the satellite captures and demodulates the data signal, and restores the data signal to an original data format; a transponder of the satellite modulates data again and transmits the data back to the earth through different frequencies and beams, a target is the satellite receiving terminal on the ground;
the satellite receiving terminal comprises an antenna, a low-noise amplifier and a receiver, and captures a signal transmitted from the satellite; the receiver demodulates the signal, restores the original data format, and checks and corrects the data through an internal processing system to ensure an integrity and an accuracy of the data; and
after receiving and processing, the satellite receiving terminal transmits the data to the central server through wired or wireless networks.

6. The real-time monitoring system for the internal environment of the oil well platform according to claim 5, wherein the central server specifically comprises:
data receiving and preliminary processing:
receiving multi-source data from the satellite receiving terminal, wherein the multi-source data reflects environmental conditions in the oil well platform, comprising temperature, humidity, dust condition, water quality, toxic gas and pressure data; and preprocessing the received data, comprising verifying data integrity, correcting errors and removing redundant or inconsistent information;
data integration:
through principal component analysis, data from different sensors and devices are integrated to ensure a compatibility and a consistency of various data, and cleaned data are stored in a structured database by using a database management system to realize functions of data organization, query and retrieval; and
data analysis:
using a data analysis technology and a machine learning algorithm deeply analyzing the integrated data in the database, comprising pattern recognition, anomaly detection and trend prediction; and
using an artificial intelligence technology, explaining analysis results, identifying environmental risk factors, predicting future conditions, and generating corresponding reports.

7. The real-time monitoring system for the internal environment of the oil well platform according to claim 6, characterized in that the principal component analysis specifically comprises following steps:
standardizing the data to obtain a standardized data matrix Z;
calculating a covariance matrix to find principal component of the data; for the standardized data matrix Z, defining the covariance matrix C as:
$$C = \frac{1}{n - 1} {Z}^{T} Z ,$$
wherein Z^{T} represents an transposition of Z, and n represents a number of samples;
calculating an eigenvalue λ and an eigenvector v: Cv=λv;
selecting the principal component:
after finding eigenvalues and eigenvectors, sorting eigenvalues from large to small, wherein a eigenvector corresponding to first k largest eigenvalues is first k principal components, and transforming original data into a new space through the eigenvector;
data transformation:
transforming the original data matrix X into a new low-dimensional data matrix Y through selected principal components: Y=Zvₖ,
wherein vₖ represents a matrix composed of the first k principal components.

8. The real-time monitoring system for the internal environment of the oil well platform according to claim 7, wherein the data analysis technology of a central processing unit is based on an autoregressive moving average model, and the model formula is:
$$Xt = c + {φ}_{1} {Xt}_{- 1} + … + φ pXt - t - {θ}_{1} ε {t}_{- 1} - … - θ q εt\_q + ε t ,$$
wherein
Xt represents time series data, c represents a constant term; θ₁ to θp represent parameters of an autoregressive term, and describes a dependence of past p periods; θ₁ to θq represent parameters of a moving average term, and describes a dependence of a model error term; εt represents an error term, assuming white noise; p, q represent respectively orders of the autoregressive term and the moving average term; and the model predicts a future value of time series by combining past observation values and past errors.

9. The real-time monitoring system for the internal environment of the oil well platform according to claim 8, wherein the machine learning algorithm of the central processing unit is based on Random Forest, and a formula is:
$$Y = ( 1 / N ) \times \sum ( {T}_{i} ( X ) )$$
wherein
Y represents a predicted output, N represents a number of decision trees, Tᵢ(X) represents a prediction of an i-th tree, and X represents an input variable.

10. The real-time monitoring system for the internal environment of the oil well platform according to claim 9, wherein the control center specifically comprises:
definition of safety parameters: according to historical data and industry safety standards, defining a safety range and a warning line of each monitoring factor;
real-time data monitoring: monitoring well site environment in real time by using the sensor data collected by the edge computing equipment, and synchronizing the data to the central database after preprocessing and analysis;
anomaly detection algorithm: constantly comparing real-time data with a normal operating range, and triggering an anomaly detection protocol immediately in case of any deviation from preset security parameters, wherein the anomaly detection algorithm is anomaly detection based on clustering, normal data is considered to constitute “clusters” in a data set, and outliers are points far away from the nearest cluster; the algorithm first clusters the data, and then identifies data points not belong to the clusters; and
early warning signal triggering: once the parameters are detected to be beyond the safe range or reach the warning line, the early warning system automatically triggers, and immediately sends out visual and audible alarms in the control center through the built-in communication module.
